(19) United States
(12) Patent Application Publication
(10) Pub. No.: US 2025/0250907 A1
(43) Pub. Date: Aug. 7, 2025

(54) ELECTRICAL POWER MANAGEMENT SYSTEM FOR A HYPERSONIC VEHICLE

(71) Applicant: General Electric Company, Schenectady, NY (US)

(72) Inventors: Gregory Alexander Natsui, Schenectady, NY (US); Ahmed Elasser, Latham, NY (US); Nicholas William Rathay, Rock City Falls, NY (US)

(21) Appl. No.: 18/432,354

(22) Filed: Feb. 5, 2024

(51) Int. Cl. F01D 15/10; B64C 30/00; F01D 17/04; F01D 21/00; F03H 1/00

(52) U.S. Cl. CPC F01D 15/10; B64D 41/00; F01D 17/04; B64C 30/00; B64D 2221/00; F01D 21/003; F03H 1/0018

(57) ABSTRACT

An electrical power management system includes a primary electrical system, an auxiliary electrical system including a plasma device, and a turbine generator. The primary electrical system is configured to exert a primary electrical load on the turbine generator, and the auxiliary electrical system is configured to exert a governing electrical load on the turbine generator via the plasma device.

### FIELD

The present subject matter relates generally to hypersonic vehicles, more particularly, to an electrical power management system for a hypersonic vehicle.

### BACKGROUND

State of the art hypersonic platforms utilize batteries for in-flight power. As flight duration increases, the mass and volume of the batteries also increases due to an increase in kilowatt-hours (kW-hrs) required to complete longer missions.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a top-side view of an exemplary hypersonic vehicle in accordance with an exemplary aspect of the present disclosure.

FIG. 2 is a bottom-side view of the exemplary hypersonic vehicle shown in FIG. 1, in accordance with an exemplary aspect of the present disclosure.

FIG. 3 is a side view of the hypersonic vehicle as shown in FIGS. 1 and 2, including a cross-sectional, schematic view of an exemplary hypersonic propulsion system including a hypersonic propulsion engine, in accordance with an exemplary embodiment of the present subject matter.

FIG. 4 is a schematic of an electrical power management system for a hypersonic vehicle in accordance with an exemplary embodiment of the present disclosure.

FIG. 5 is a schematic top view of the hypersonic vehicle as illustrated in FIGS. 1-3 with a portion of a top-side removed and including the electrical power management system shown in FIG. 4, in accordance with exemplary embodiments of the present disclosure.

FIG. 6 is a top-side view of the exemplary hypersonic vehicle as shown in FIG. 1 and illustrating various plasma device locations in accordance with exemplary embodiments of the present disclosure.

FIG. 7 is a bottom-side view of the exemplary hypersonic vehicle as shown in FIG. 6 and illustrating various plasma device locations in accordance with exemplary embodiments of the present disclosure.

FIG. 8 is a side view of the hypersonic vehicle as shown in FIG. 3 including a cross-sectional, schematic view of the exemplary hypersonic propulsion system including the hypersonic propulsion engine and a portion of the electrical power management system in accordance with an exemplary embodiment of the present subject matter.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations.

As used herein, the terms “first,” “second,” and “third” may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, regarding a gas turbine engine, forward refers to a position closer to an engine inlet section and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

State of the art hypersonic platforms utilize batteries for in-flight power. However, as flight duration increases batteries alone become mass and volume prohibitive due to an increased demand of kW-hrs. As such, onboard power generation solutions are needed to support longer missions.

The current disclosure provides an onboard power generator in the form of a turbomachine, such as but not limited to an expansion turbine, to provide power to a primary electrical system. A secondary or auxiliary electrical system is provided to govern shaft speed of the turbine generator in instances when a primary electrical load suddenly changes such as in a sudden increase or decrease in the primary electrical load. The auxiliary electrical system utilizes one or more plasma devices such as a plasma actuator or plasma sensor disposed at various locations of the hypersonic vehicle to dissipate excess electrical power generated by the onboard power generator so as to manage or govern shaft speed.

The plasma devices may have various uses including, but not limited to, drag reduction on the hypersonic vehicle exterior surfaces, an ignition source, and hypersonic boundary layer or “BL” control. There are many regions on a vehicle where excess plasma can be generated without any detrimental impact on vehicle performance. For example, a plasma device may be disposed along or proximate to a leading edge of the fuselage, a wing, and a rudder. In addition, or in the alternative, a plasma device may be disposed upstream from or within a propulsion system or engine (e.g., a scramjet or ramjet engine), integrated into an igniter of a combustor of the propulsion system, or disposed within or just downstream from an exhaust nozzle of the propulsion system. The system disclosed herein, a ‘plasma governor’, solves inevitable challenges with managing turbomachine or shaft speed in a manner which may boost overall electrical system and aerodynamic performance of a hypersonic vehicle.

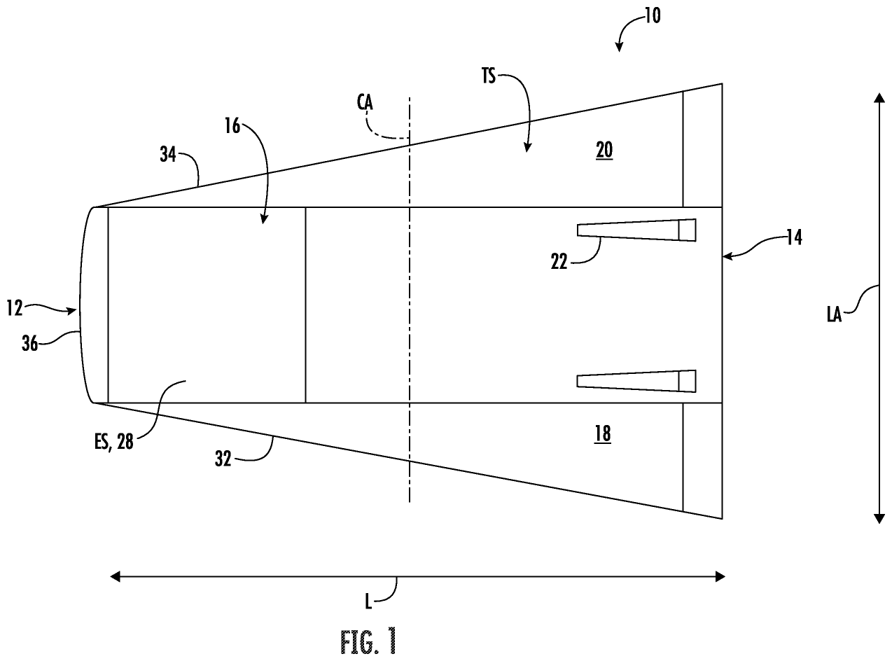

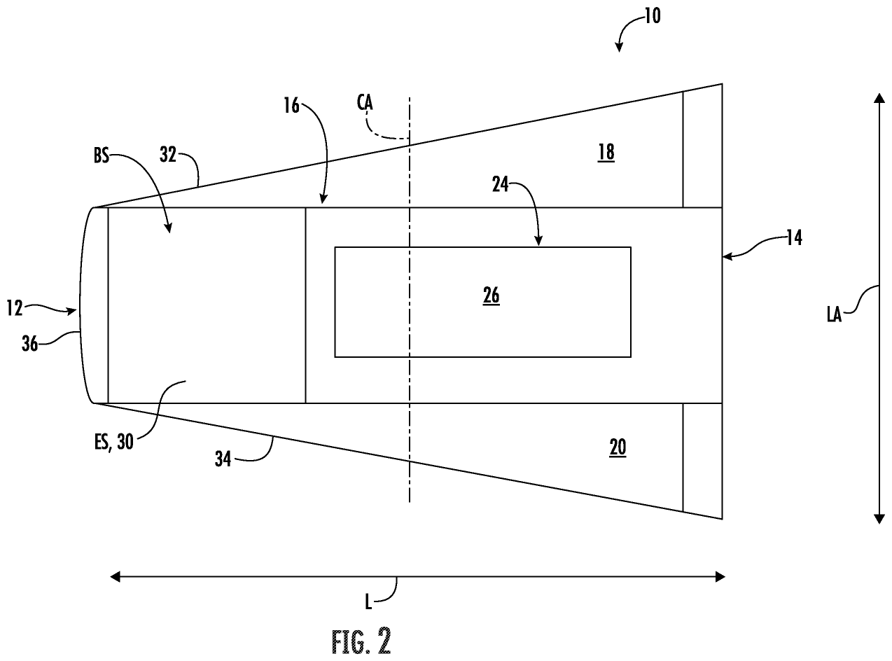

Referring now to the drawings, wherein identical numerals indicate the same elements throughout the figures, FIG. 1 provides a top-side view of an exemplary hypersonic vehicle 10 in accordance with an exemplary aspect of the present disclosure. FIG. 2 provides a bottom-side view of the exemplary hypersonic vehicle 10 shown in FIG. 1, in accordance with an exemplary aspect of the present disclosure. As shown in FIGS. 1 and 2, the hypersonic vehicle 10 generally defines a lateral direction “LA”, a longitudinal direction “L”, a vertical direction (not labeled), a top-side “TS” (FIG. 1) and a bottom-side “BS” (FIG. 2). The vertical direction is perpendicular to the lateral direction LA and the longitudinal direction L.

The hypersonic vehicle 10 extends generally along the longitudinal direction L between a forward end 12 and an aft end 14. For the embodiment shown, the hypersonic vehicle 10 includes a main body or fuselage 16, a first wing 18 extending laterally outward from a port side of the fuselage 16, and a second wing 20 extending laterally outward from a starboard side of the fuselage 16. As shown in FIG. 1, the hypersonic vehicle may include at least one vertically extending stabilizer or rudder 22 (two shown) extending vertically outwardly from the top-side TS. As shown in FIGS. 1 and 2, the fuselage 16 defines a central axis “CA”. The central-axis CA is defined as a longitudinal line that is equidistance from the forward end 12 and the aft end 14 of the hypersonic vehicle 10 as measure along the longitudinal direction L.

As shown in FIG. 2, the hypersonic vehicle 10 includes a hypersonic propulsion system 24 mounted to or extending from and/or along the bottom-side BS of the hypersonic vehicle 10. In the exemplary hypersonic vehicle 10 shown, the hypersonic propulsion system 24 includes a hypersonic propulsion engine 26. Although only one hypersonic propulsion engine 26 is shown, it is to be appreciated that the hypersonic propulsion system 24 may include more than one hypersonic propulsion engine 26. It is also to be appreciated that the hypersonic propulsion engine 26 may be mounted or extend from the top-side TS (FIG. 1) of the hypersonic vehicle 10 in other embodiments.

In the exemplary embodiment shown in FIGS. 1 and 2 collectively, the fuselage 16, the first wing 18, the second wing 20, the at least one vertically extending stabilizer or rudder 22, and a portion of the hypersonic propulsion engine 26, define an exterior surface “ES” or skin of the hypersonic vehicle 10. The exterior surface ES is generally divided into an upper exterior surface 28 defined along the top-side TS of the hypersonic vehicle 10 as shown in FIG. 1, and a lower exterior surface 30 defined along the bottom-side BS of the hypersonic vehicle 10 as illustrated in FIG. 2. The upper exterior surface 28 may be generally defined above a leading edge 32 of first wing 18 and a leading edge 34 of second wing 20. The lower exterior surface 30 is generally defined below the leading edge 32 of first wing 18 and the leading edge 34 of second wing 20. The upper exterior surface 28 of the hypersonic vehicle 10 (FIG. 1) and the lower exterior surface 30 (FIG. 2) merge or meet at the forward end 12 to define a leading edge 36 of the hypersonic vehicle 10.

Notably, the exemplary hypersonic vehicle 10 depicted in FIG. 1 and FIG. 2 is provided by way of example only, and in other embodiments may have any other suitable configuration. For example, in other embodiments, the fuselage 16 may have any other suitable shape (such as a more pointed, aerodynamic shape, different stabilizer shapes and orientation, etc.), the propulsion system may have any other suitable engine arrangement (e.g., an engine incorporated into the vertical stabilizer), and/or any other suitable configuration.

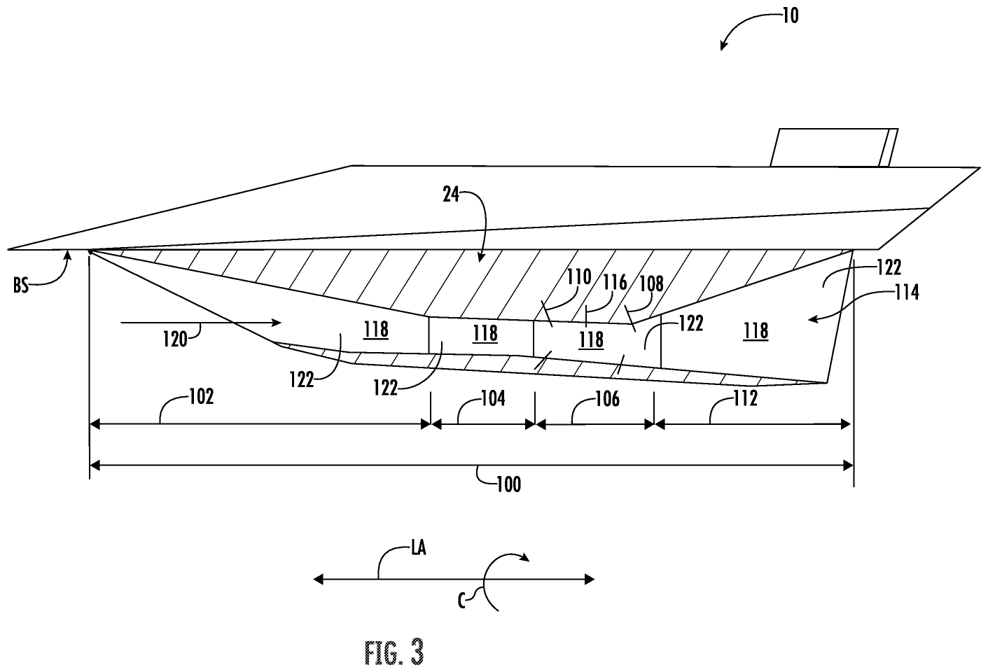

As will be appreciated, the hypersonic propulsion system 24 is configured for propelling the hypersonic vehicle 10 from takeoff (e.g., 0 miles per hour up to around 150 miles per hour) up and to hypersonic flight. It will be appreciated, that as used herein, the term “hypersonic” refers generally to air speeds of about Mach 3 up to about Mach 10, such as about Mach 5 and up. FIG. 3 is a side view of the hypersonic vehicle 10 as shown in FIGS. 1 and 2, including a cross-sectional, schematic view of an exemplary hypersonic propulsion system 24 including an exemplary hypersonic propulsion engine 100 mounted to or integrated with the bottom-side BS of the hypersonic vehicle 10 in accordance with an exemplary embodiment of the present subject matter. In exemplary embodiments, the hypersonic propulsion engine 100 may be representative of hypersonic propulsion engine 26 shown in FIG. 2.

As shown in FIG. 3, the hypersonic propulsion engine 100 may be configured as a ramjet/scramjet/dual-mode ramjet engine. As shown in FIG. 3, the hypersonic propulsion engine 100 generally extends along lateral direction LA, the radial direction, and a circumferential direction C. As shown in FIG. 3, the hypersonic propulsion engine 100 generally includes an engine inlet section 102, an isolator section 104, a combustor 106, a main injector 108, a shock train fuel injector 110, and a nozzle section 112 defining an engine exhaust 114 or outlet. In exemplary embodiments, the combustor 106 includes an igniter 116. In serial flow order, the engine inlet section 102, the isolator section 104, the combustor 106, and the nozzle section 112 including the engine exhaust 114 or outlet at least partially define an air flowpath 118 through the hypersonic propulsion engine 100.

In operation, the engine inlet section 102 is configured to compress, via supersonic compression, incoming air 120 before combustion. The isolator section 104 is disposed between the engine inlet section 102 and the combustor 106 and is configured to improve the homogeneity of the flow in the combustor 106 and to extend the operating range of the engine.

The combustor 106 is configured to burn one or more fuel types such as but not limited to gaseous fuel, liquid fuel, or solid fuel, with atmospheric oxygen to produce heat. The shock train fuel injector 110 is located between the isolator section 104 and the combustor 106. The shock train fuel injector 110 is configured to modulate fuel flow to the engine to control back pressure produced by the engine to limit unstart. The main injectors 108 are typically located between the combustor 106 and the nozzle section 112 and are configured to supply fuel for combustion in the combustor 106. The engine inlet section 102, the isolator section 104, the combustor 106, and the nozzle section 112 including the engine exhaust 114 or outlet at least partially define an interior surface 122 of the hypersonic propulsion engine 100 that extends through the engine inlet section 102, the isolator section 104, the combustor 106, and the nozzle section 112.

It is to be appreciated that in other configurations, the hypersonic propulsion system may include or comprise a gas turbine engine. In other configurations, a TBCC (turbine+scramjet) may be used to takeoff and cruise at greater than about M>5. There are other instances where a turbine engine is not required and an air-launch of the vehicle, such as a plane launch and rocket boost, before transitioning to the hypersonic propulsion (scramjet) system may be utilized.

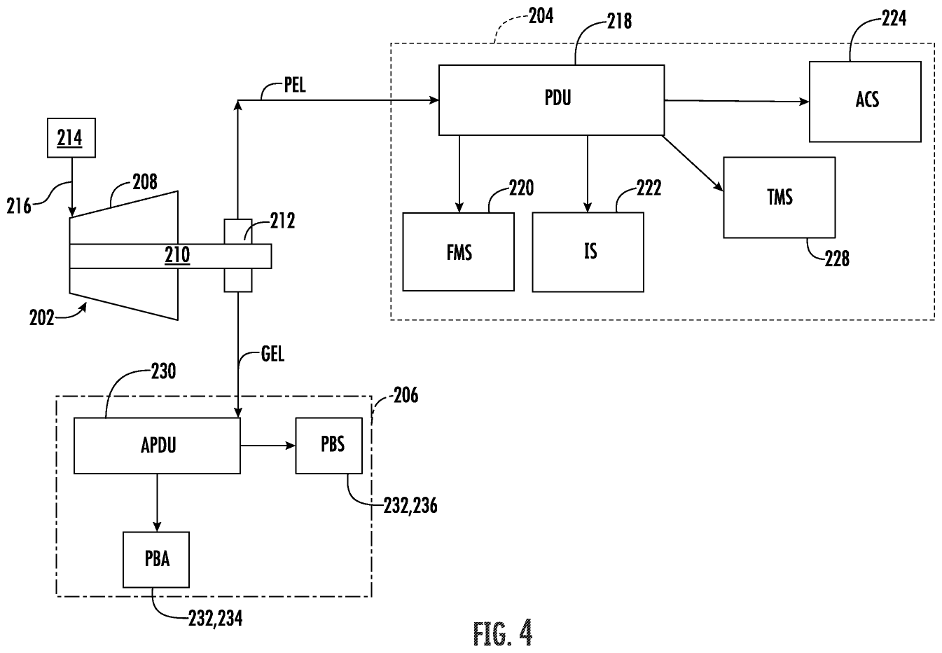

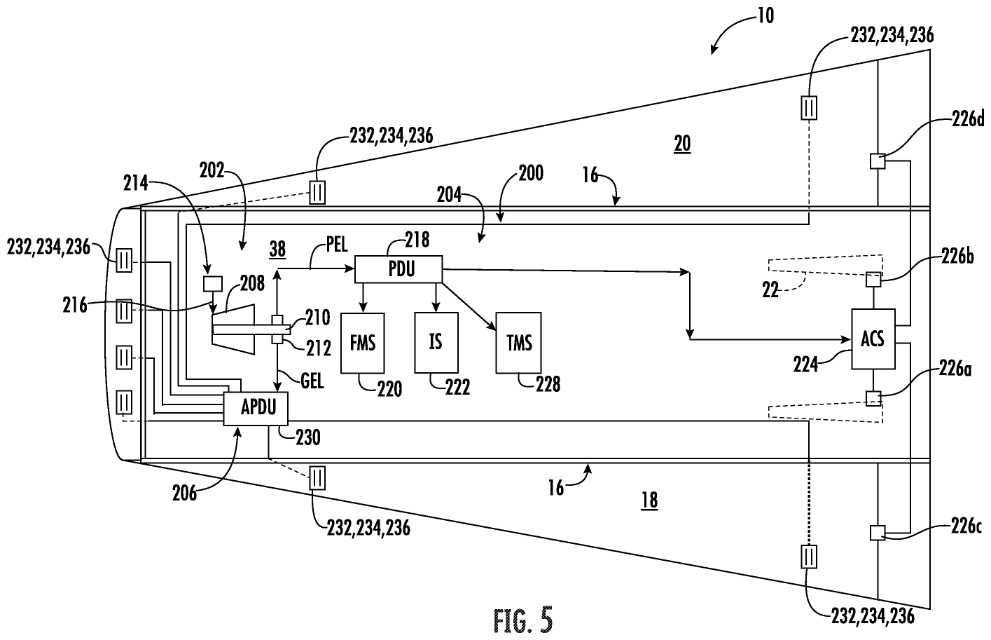

As previously discussed, a hypersonic vehicle requires electrical power to drive various systems required for flight. FIG. 4 is a schematic of an electrical power management system 200 for a hypersonic vehicle in accordance with an exemplary embodiment of the present disclosure. FIG. 5 is a schematic top view of the hypersonic vehicle 10 as illustrated in FIGS. 1-3 with a portion of the top-side TS removed and including the electrical power management system 200 shown in FIG. 4, in accordance with exemplary embodiments of the present disclosure.

As shown in FIGS. 4 and 5 collectively, the electrical power management system 200 includes a turbine generator 202, a primary electrical system 204 electrically connected to the turbine generator 202, and an auxiliary electrical system 206 electrically connected to the turbine generator 202. The turbine generator 202 includes an exemplary turbomachine such as an expansion turbine 208 including a rotor shaft 210, and a generator 212 mechanically coupled to the rotor shaft 210. The expansion turbine 208 may be fluidly connected to a working fluid source 214 for providing a working fluid 216 such as, but not limited to, compressed air, a monopropellant, or other suitable working fluid or gas for driving the expansion turbine 208. As shown in FIG. 5, the turbine generator 202 is disposed and enclosed within an interior space 38 or volume of the fuselage 16 defined between the upper exterior surface 28 (FIG. 1) and the lower exterior surface 30 (FIG. 2).

Referring back to FIGS. 4 and 5, the primary electrical system 204 includes a primary power distribution unit 218 electrically connected to the generator 212. The primary power distribution unit 218 is configured to receive electrical power from the generator 212 and to exert or draw a primary electrical load “PEL” on the turbine generator 202 during operation of the electrical power management system 200. In exemplary embodiments, the primary electrical system 204 includes one or more systems or devices which require electrical power for operation and that are electrically connected to the primary power distribution unit 218 and thus contribute to the primary electrical load PEL exerted on the generator 212. For example, in certain embodiments, the primary power distribution unit 218 of the primary electrical system 204 may provide electrical power to one or more of a flight management system 220, an instrumentation system 222 for providing power to various onboard instruments, an actuator control system 224 for manipulating various flight control surfaces, and a thermal management system 228 for controlling onboard temperatures.

In exemplary embodiments, as shown in FIG. 5, the actuator control system 224 may be electrically connected to one or more actuators 226a, 226b to control or manipulate the one or more vertically extending stabilizers or rudders 22 (shown in phantom lines). In addition, or in the alternative, the actuator control system 224 may be electrically connected to one or more actuators 226c, 226d to control or manipulate the first wing 18 and the second wing 20 respectively.

As further shown in FIGS. 4 and 5, the auxiliary electrical system 206 includes an auxiliary power distribution unit 230 electrically connected to the generator 212. The auxiliary power distribution unit 230 is configured to receive electrical power from the generator 212 and to exert or draw an auxiliary or governing electrical load “GEL” on the turbine generator 202 during operation of the electrical power management system 200. In exemplary embodiments, the auxiliary electrical system 206 includes one or more systems or devices which may utilize or discharge electrical power from the turbine generator 202 during operation of the hypersonic vehicle 10 and thus contribute to the governing electrical load GEL. For example, in certain embodiments, the auxiliary power distribution unit 230 of the auxiliary electrical system 206 may provide electrical power to a plasma device 232. In particular embodiments, the auxiliary power distribution unit 230 of the auxiliary electrical system 206 may provide electrical power to a plurality of plasma devices 232.

As used herein, the term “plasma device” includes, by way of example and not limitation unless otherwise provided, any device capable of creating plasma which is utilized to alter the characteristics of surfaces such as but not limited to a plasma-based actuator, any device capable of creating plasma to ignite fuel such as but not limited to a plasma ignition plug or igniter, and any device capable of using plasma to measure flow mass-flux to sense pressure such as but not limited to a plasma-based sensor. In exemplary embodiments, as shown in FIG. 4, the plasma device 232 includes a plasma-based actuator 234. In other embodiments the plasma device 232 includes a plasma-based sensor 236. In exemplary embodiments, as shown in FIG. 5, the auxiliary electrical system 206 includes a plurally of plasma devices 232 which includes both plasma-based actuators 234 and plasma-based sensors 236.

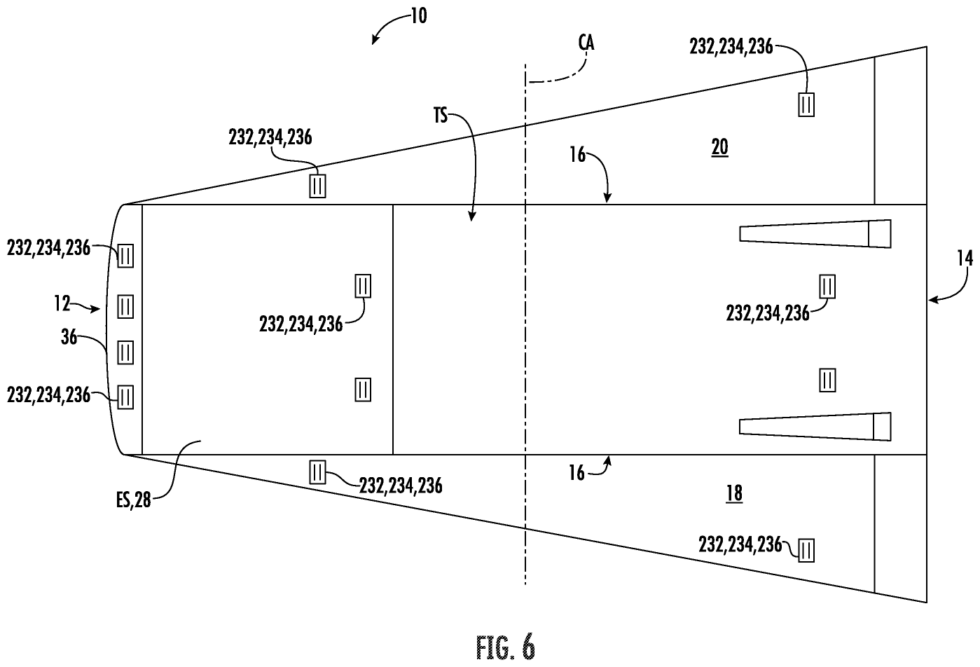

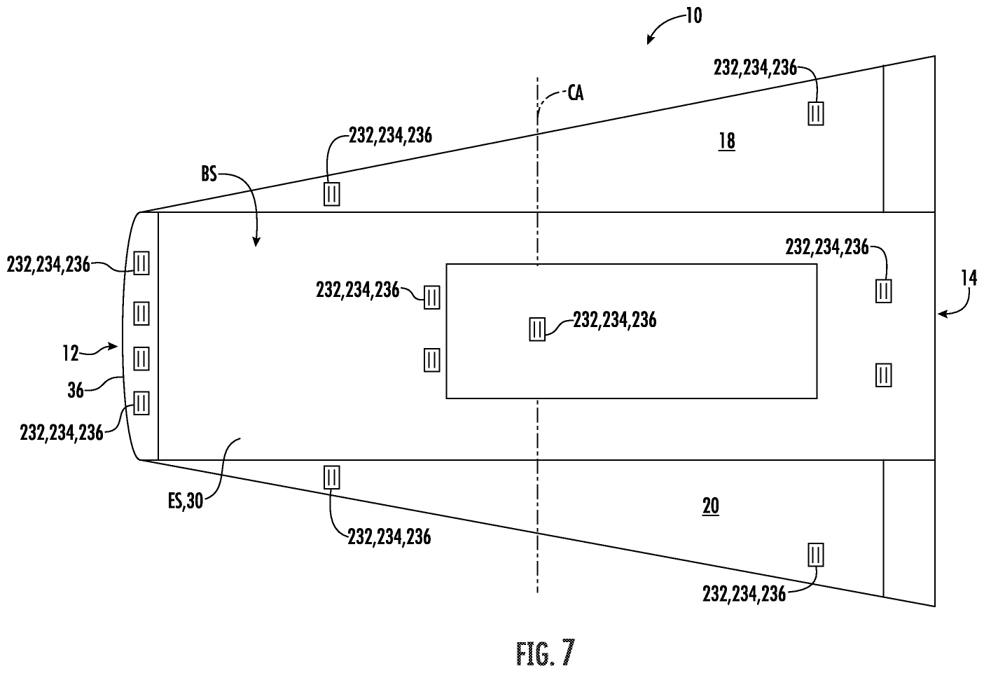

FIG. 6 provides a top-side view of the exemplary hypersonic vehicle 10 as shown in FIG. 1 illustrating various plasma device locations in accordance with exemplary embodiments of the present disclosure. FIG. 7 provides a bottom-side view of the exemplary hypersonic vehicle 10 shown in FIG. 6 illustrating various plasma device locations in accordance with exemplary embodiments of the present disclosure.

As shown in FIG. 6, the plasma device 232 may be disposed along or beneath the exterior surface ES of the hypersonic vehicle 10 along the upper exterior surface 28. For example, at least one plasma device 232 may be positioned along or beneath the upper exterior surface 28 between the leading edge 36 and the central-axis CA, at or proximate to the forward end 12 or leading edge 36 of the fuselage 16, between the central-axis CA and the aft end 14 of the fuselage, along first wing 18, and along second wing 20. In exemplary embodiments, as shown in FIG. 6, the plasma device 232 may include a plasma-based actuator 234, a plasma-based sensor 236, or there may be any combination of plasma-based actuators 234 and plasma-based sensors 236.

As shown in FIG. 7, the plasma device 232 may be disposed along or beneath the exterior surface ES of the hypersonic vehicle 10 along the lower exterior surface 30. For example, at least one plasma device 232 may be positioned along or beneath the lower exterior surface 30 between the leading edge 36 and the central-axis CA, at or proximate to the forward end 12 or leading edge 36 of the fuselage 16, between the central-axis CA and the aft end 14 of the fuselage, along first wing 18, and along second wing 20. In exemplary embodiments, as shown in FIG. 7, plasma device 232 may include a plasma-based actuator 234, a plasma-based sensor 236, or there may be any combination of plasma-based actuators 234 and plasma-based sensors 236.

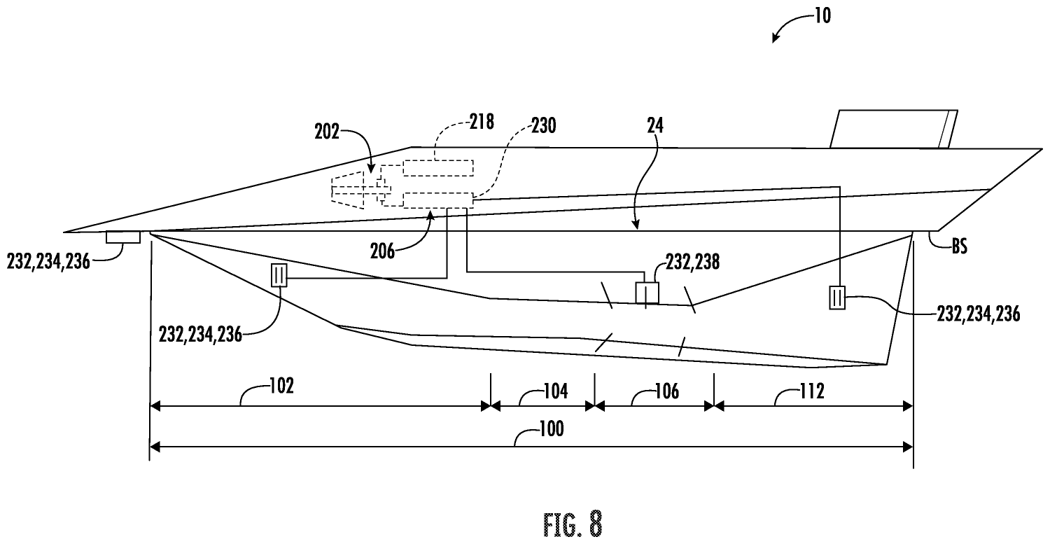

FIG. 8 is a side view of the hypersonic vehicle 10 as shown in FIG. 3, including a cross-sectional, schematic view of the exemplary hypersonic propulsion system 24 including the hypersonic propulsion engine 100 mounted to or integrated with the bottom-side BS of the hypersonic vehicle 10, the turbine generator 202 (shown in hidden lines), and a portion of the electrical power management system 200 including the auxiliary power distribution unit 230 and the primary power distribution unit 218, in accordance with an exemplary embodiment of the present subject matter. In exemplary embodiments, the auxiliary electrical system 206 may include a plurality of plasma devices 232 positioned within the engine inlet section 102, including a plasma device 232 positioned upstream from the engine inlet section 102, a plasma device 232 positioned within the nozzle section 112, a plasma device 232 electrically connected to the igniter 116, or any combination thereof. The plasma device(s) 232 may include a plasma-based actuator 234, a plasma-based sensor 236, a plasma-based igniter 238 or any combination thereof.

In operation, when the primary electrical load suddenly decreases, power electronics controlling the electrical power management system will sense the reduction in the primary electrical load on the system and divert the excess power to the auxiliary electrical system in order to maintain speed/voltage/or some other control variable so that the turbomachine or expansion turbine does not experience any change in shaft torque as the generator decreases torque from the reduction in the primary electrical load. In certain instances, the auxiliary electrical load may be higher than the primary electrical load in anticipation of a sudden increase of the primary electrical load in order to maintain speed/voltage/or some other control variable so that the turbomachine or expansion turbine does not experience any change in shaft torque as the generator increases torque from the increase in the primary electrical load.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the disclosure are provided by the subject matter of the following clauses:

An electrical power management system, comprising: a primary electrical system; an auxiliary electrical system including a plasma device; and a turbine generator, wherein the primary electrical system is configured to exert a primary electrical load on the turbine generator, and wherein the auxiliary electrical system is configured to exert a governing electrical load on the turbine generator via the plasma device.

The electrical power management system of the preceding or any following clause, wherein the auxiliary electrical system is configured to increase the governing electrical load on the turbine generator when the primary electrical load is decreased.

The electrical power management system of any preceding or any following clause, wherein the auxiliary electrical system is configured to decrease the governing electrical load on the turbine generator when the primary electrical load is increased.

The electrical power management system of any preceding or any following clause, wherein the plasma device is a plasma-based actuator.

The electrical power management system of any preceding or any following clause, wherein the plasma device is a plasma-based sensor.

The electrical power management system of any preceding or any following clause, wherein the plasma device is a plasma-based igniter.

A hypersonic vehicle, comprising: an electrical power management system, the electrical power management system comprising: a primary electrical system; an auxiliary electrical system; and a turbine generator, wherein the primary electrical system is configured to exert a primary electrical load on the turbine generator, and wherein the auxiliary electrical system is configured to exert a governing electrical load on the turbine generator.

The hypersonic vehicle the preceding or any following clause, wherein the auxiliary electrical system is configured to increase the governing electrical load on the turbine generator when the primary electrical load is decreased.

The hypersonic vehicle of any preceding or any following clause, wherein the auxiliary electrical system is configured to decrease the governing electrical load on the turbine generator when the primary electrical load is increased.

The hypersonic vehicle of any preceding or any following clause, further comprising a fuselage, wherein the turbine generator is mounted within the fuselage.

The hypersonic vehicle of any preceding or any following clause, further comprising a fuselage defining an exterior surface, wherein the auxiliary electrical system includes a plasma device disposed along or beneath the exterior surface.

The hypersonic vehicle of any preceding or any following clause, wherein the plasma device is a plasma-based actuator.

The hypersonic vehicle of any preceding or any following clause, wherein the plasma device is a plasma-based sensor.

The hypersonic vehicle of any preceding or any following clause, wherein the plasma device is a plasma-base igniter.

The hypersonic vehicle of any preceding or any following clause, wherein the fuselage includes a leading edge, a central-axis, and an aft end, wherein the plasma device is positioned along or beneath the exterior surface between the leading edge and the central-axis.

The hypersonic vehicle of any preceding or any following clause, wherein the fuselage includes a leading edge, a central-axis, and an aft end, wherein the plasma device is positioned along or beneath the exterior surface between the central-axis and the aft end.

The hypersonic vehicle of any preceding or any following clause, further comprising a hypersonic propulsion system including an engine inlet section and an exhaust nozzle section partially defining an engine flowpath through the hypersonic propulsion system, wherein the auxiliary electrical system includes at least one plasma device, and wherein at least one plasma device of the at least one plasma device is positioned within the engine inlet section, upstream from the engine inlet section, or the exhaust nozzle section.

The hypersonic vehicle of any preceding or any following clause, wherein the primary electrical system is electrically connected to an actuator control system.

The hypersonic vehicle of any preceding or any following clause, wherein the primary electrical system is electrically connected to a flight management system.

The hypersonic vehicle of any preceding or any following clause, wherein the primary electrical system is electrically connected to an instrumentation system.

A method for governing shaft speed of a turbine generator for a hypersonic vehicle, the method comprising: exerting a primary electrical load on a turbine generator; exerting a governing electrical load on the turbine generator; increasing the governing electrical load on the turbine generator when the primary electrical load decreases; and decreasing the governing electrical load on the turbine generator when the primary electrical load increases.

The method of the preceding or any following clause, wherein exerting the governing electrical load on the turbine generator comprises sending electrical power from the turbine generator to one or more plasma devices.

The method of the preceding or any following clause, wherein exerting the governing electrical load on the turbine generator comprises controlling airflow across an exterior surface of the hypersonic via the plasma device.

The method of any preceding or any following clause, wherein the one or more plasma devices includes a plasma actuator.

The method of any preceding or any following clause, wherein the one or more plasma devices includes a plasma sensor.

What is claimed is:

1. An electrical power management system, comprising:
a primary electrical system;
an auxiliary electrical system including a plasma device; and
a turbine generator, wherein the primary electrical system is configured to exert a primary electrical load on the turbine generator, and wherein the auxiliary electrical system is configured to exert a governing electrical load on the turbine generator via the plasma device.

2. The electrical power management system of claim 1, wherein the auxiliary electrical system is configured to increase the governing electrical load on the turbine generator when the primary electrical load is decreased.

3. The electrical power management system of claim 1, wherein the auxiliary electrical system is configured to decrease the governing electrical load on the turbine generator when the primary electrical load is increased.

4. The electrical power management system of claim 1, wherein the plasma device is a plasma-based actuator.

5. The electrical power management system of claim 1, wherein the plasma device is a plasma-based sensor.

6. The electrical power management system of claim 1, wherein the plasma device is a plasma-based igniter.

7. A hypersonic vehicle, comprising:
an electrical power management system, comprising:
a primary electrical system;
an auxiliary electrical system; and
a turbine generator, wherein the primary electrical system is configured to exert a primary electrical load on the turbine generator, and wherein the auxiliary electrical system is configured to exert a governing electrical load on the turbine generator.

8. The hypersonic vehicle of claim 7, wherein the auxiliary electrical system is configured to increase the governing electrical load on the turbine generator when the primary electrical load is decreased.

9. The hypersonic vehicle of claim 7, wherein the auxiliary electrical system is configured to decrease the governing electrical load on the turbine generator when the primary electrical load is increased.

10. The hypersonic vehicle of claim 7, further comprising a fuselage, wherein the turbine generator is mounted within the fuselage.

11. The hypersonic vehicle of claim 7, further comprising a fuselage defining an exterior surface, wherein the auxiliary electrical system includes a plasma device disposed along or beneath the exterior surface.

12. The hypersonic vehicle of claim 11, wherein the plasma device is a plasma-based actuator.

13. The hypersonic vehicle of claim 11, wherein the plasma device is a plasma-based sensor.

14. The hypersonic vehicle of claim 11, wherein the plasma device is a plasma-based igniter.

15. The hypersonic vehicle of claim 11, wherein the fuselage includes a leading edge, a central-axis, and an aft end, wherein the plasma device is positioned along or beneath the exterior surface between the leading edge and the central-axis.

16. The hypersonic vehicle of claim 11, wherein the fuselage includes a leading edge, a central-axis, and an aft end, wherein the plasma device is positioned along or beneath the exterior surface between the central-axis and the aft end.

17. The hypersonic vehicle of claim 7, further comprising a hypersonic propulsion system including an engine inlet section and an exhaust nozzle section partially defining an engine flowpath through the hypersonic propulsion system, wherein the auxiliary electrical system includes at least one plasma device positioned within the engine inlet section, upstream from the engine inlet section, or the exhaust nozzle section.

18. The hypersonic vehicle of claim 7, wherein the primary electrical system is electrically connected to an actuator control system.

19. The hypersonic vehicle of claim 7, wherein the primary electrical system is electrically connected to a flight management system.

20. The hypersonic vehicle of claim 7, wherein the primary electrical system is electrically connected to an instrumentation system.
